(19) United States
(12) Patent Application Publication
(10) Pub. No.: US 2022/0177260 A1
(43) Pub. Date: Jun. 9, 2022

(54) WEBBING TAKE-UP DEVICE

(71) Applicant: KABUSHIKI KAISHA TOKAI-RIKA-DENKI-SEISAKUSHO, Aichi (JP)

(72) Inventor: Chihiro MATSUOKA, Aichi (JP)

(21) Appl. No.: 17/441,426

(22) PCT Filed: Mar. 30, 2020
(86) PCT No.: PCT/JP2020/014550

§ 371 Date: Sep. 21, 2021

(30) Foreign Application Priority Data
Apr. 9, 2019 (JP) 2019-074160

(51) Int. Cl. B65H 75/44; B60R 22/343

(52) U.S. Cl. CPC B65H 75/4428; B65H 2555/13; B60R 22/343

(57) ABSTRACT

A mechanism that limits pulling out of a webbing from a spool is electrically activated. A webbing take-up device is provided with the spool, a pawl, magnets, and a coil. In a case in which displaced to a locking position, the pawl locks rotation of the spool in the pull-out direction. The magnets are fixed to the pawl. The coil is formed by winding of a conductive wire and is disposed in close proximity with the magnets. The pawl is displaced or urged by electric current being applied to the coil.

### TECHNICAL FIELD

The present invention relates to a webbing take-up device.

### BACKGROUND ART

European Patent Application Publication No. 460494 discloses a webbing take-up device equipped with a lock mechanism that limits pulling out of a webbing from a spool at a time of rapid deceleration of a vehicle or when the webbing is suddenly pulled out from the spool. In the lock mechanism of the webbing take-up device recited in this Reference, a claw (pawl) to which a permanent magnet is fixed engages with inner teeth of a blocking component, and locking teeth engage with a housing pawl. Thus, rotation of the spool is locked, which limits pulling out of the webbing from the spool. In the webbing device recited in this Reference, the pawl to which the permanent magnet is fixed is displaced toward a side thereof at which the inner teeth of the blocking component are disposed by electric current being applied to a coil of an electromagnet.

As described above, webbing take-up devices that electrically activate a lock mechanism that limits pulling out of a webbing from a spool are known.

### SUMMARY OF INVENTION

### Technical Problem

In consideration of the circumstances described above, a webbing take-up device is provided that may electrically activate a mechanism that limits pulling out of a webbing from a spool.

### Solution to Problem

A webbing take-up device according to a first aspect includes: a spool onto which is taken up a webbing that is configured to be applied to a vehicle occupant, the spool being rotated in a pull-out direction by the webbing being pulled out; a locking member that is integrally rotatable with the spool and displaceable relative to the spool, the locking member locking rotation of the spool in the pull-out direction in a case in which the locking member is displaced to a locking position; a magnet fixed to the locking member; and a coil formed by winding of a conductive wire, the coil being disposed in close proximity with the magnet, wherein the locking member is displaced or urged in a case in which electric current is applied to the coil.

In a webbing take-up device according to a second aspect, in the webbing take-up device according to the first aspect, the locking member is displaced or urged toward a locking position side thereof in a case in which electric current is applied to the coil in one direction, and the locking member is displaced or urged toward an opposite side thereof from the locking position in a case in which electric current is applied to the coil in another direction.

In a webbing take-up device according to a third aspect, in the webbing take-up device according to the first aspect or the second aspect, in a case in which a rotation speed of the spool in the pull-out direction exceeds a predetermined speed, the locking member is displaced toward the locking position by centrifugal force.

In a webbing take-up device according to a fourth aspect, in the webbing take-up device according to any one of the first to third aspects, a pair of the magnets are fixed to the locking member, and the coil is disposed between the pair of magnets.

In a webbing take-up device according to a fifth aspect, in the webbing take-up device according to any one of the first to fourth aspects, the magnet and the coil are disposed adjacent to each other in a rotation axis direction of the spool.

In a webbing take-up device according to a sixth aspect, in the webbing take-up device according to any one of the first to fifth aspects, the locking member includes a first locking member and a second locking member, and the magnet is fixed to the first locking member.

In a webbing take-up device according to a seventh aspect, the webbing take-up device according to the sixth aspect further includes a holder that is non-rotatable relative to the spool, wherein, by electric current being applied to the coil, the first locking member is displaced to the locking position, an engaged portion of the first locking member is engaged with an engaging portion of the holder, and rotation of the spool in the pull-out direction is locked.

In a webbing take-up device according to an eighth aspect, in the webbing take-up device according to the sixth aspect or the seventh aspect, the first locking member and the second locking member are each displaceable relative to the spool in at least a circumferential direction or a diameter direction of the spool.

### Advantageous Effects of Invention

In the webbing take-up device according to the first aspect, when electric current is applied to the coil, a magnetic field is generated in the vicinity of the coil. Because the coil and the magnet fixed to the locking member are disposed in close proximity, a force acting to displace the locking member is produced by the magnetic field generated by the electric current applied to the coil and a magnetic field of the magnet. Therefore, the locking member may be displaced or urged toward the locking position side thereof. Thus, in the webbing take-up device according to the first aspect, a mechanism that limits pulling out of the webbing from the spool may be activated electrically.

In the webbing take-up device according to the second aspect, the locking member may be displaced or urged toward the locking position side thereof or to the opposite side from the locking position by switching of the electric current applied to the coil.

In the webbing take-up device according to the third aspect, in a case in which the rotation speed of the spool in the pull-out direction exceeds the predetermined speed, the locking member is displaced to the locking position by centrifugal force. Therefore, rotation of the spool in the pull-out direction may be locked even when electric current cannot be applied to the coil.

In the webbing take-up device according to the fourth aspect, because the coil is disposed between the pair of magnets, the force acting to displace the locking member may be increased and may be made larger than in a structure in which the coil is disposed in close proximity to a single magnet.

In the webbing take-up device according to the fifth aspect, because the coil and the magnet are disposed adjacent to one another in the rotation axis direction of the spool, an increase in overall size of the webbing take-up device in a diameter direction (the rotation diameter direction of the spool) may be suppressed.

In the webbing take-up device according to the sixth aspect, the first locking member is electrically displaced to the locking position side or to the opposite side from the locking position, and the second locking member is displaced toward the locking position by centrifugal force.

In the webbing take-up device according to the seventh aspect, pulling out of the webbing from the spool is limited in a case in which the first locking member of the mechanism that is electrically activated engages with the holder.

In the webbing take-up device according to the eighth aspect, the first locking member and second locking member may be displaced in a compact manner in the circumferential direction or diameter direction of the spool.

### BRIEF DESCRIPTION OF DRAWINGS

FIG. 1 is an exploded perspective view showing disassembly of a webbing take-up device according to a present exemplary embodiment in a view seen from a side at which a lock mechanism is disposed.

FIG. 2 is an exploded perspective view showing disassembly of the webbing take-up device according to the present exemplary embodiment in a view seen from the opposite side from the side thereof at which the lock mechanism is disposed.

FIG. 3 is a plan view showing the lock mechanism in a state in which a small pawl limits displacement of a W pawl.

FIG. 4 is a plan view showing the lock mechanism in a state in which the small pawl is engaged with a sensor holder.

FIG. 5 is a plan view showing the lock mechanism in a state in which the small pawl is disposed at a middle position.

FIG. 6 is a plan view showing a W pawl and coil structuring a portion of a lock mechanism according to an alternative embodiment.

FIG. 7 is a sectional view showing the W pawl and coil, cut along line 7-7 shown in FIG. 6, showing a state in which electric current is applied to the coil in one direction.

FIG. 8 is a side view corresponding with FIG. 7, showing a state in which electric current is applied to the coil in the other direction.

FIG. 9 is a side view corresponding with FIG. 7, showing a state in which electric current is not applied to the coil.

### DETAILED DESCRIPTION

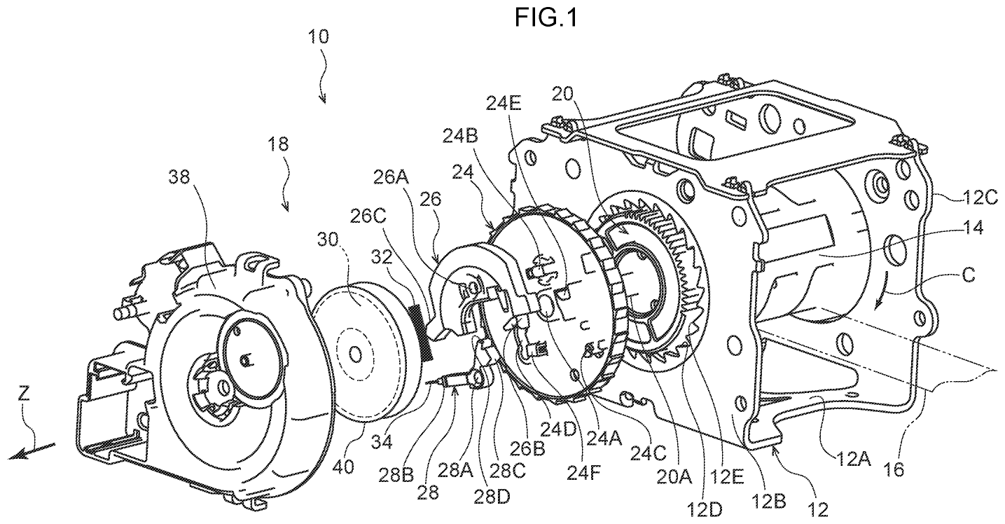

A webbing take-up device according to an exemplary embodiment of the present invention is described using FIG. 1 to FIG. 5.

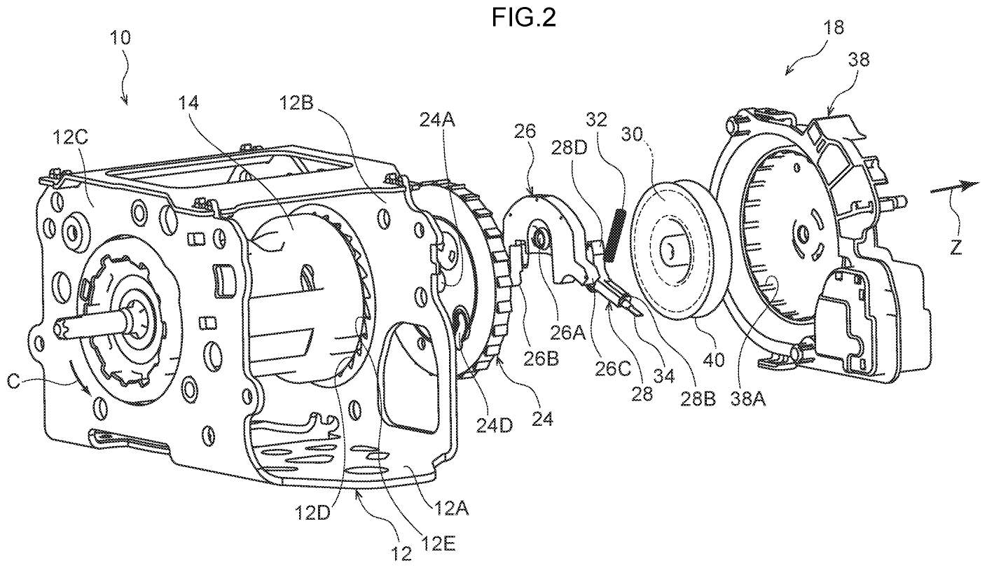

As shown in FIG. 1 and FIG. 2, a webbing take-up device 10 according to the present exemplary embodiment is provided with a frame 12, a spool 14, a webbing 16 and a lock mechanism 18. Where simply an axis direction, diameter direction, and circumferential direction are referred to below without being particularly specified, these refer to the rotation axis direction, rotation diameter direction and rotation circumferential direction of the spool.

The frame 12 is provided with a plate-shaped back plate 12A that is fixed to a vehicle body. Leg plates 12B and 12C protrude substantially perpendicularly from both of width direction (axis direction) end portions of the back plate 12A. The lock mechanism 18, which is described below, is provided at a side of the frame 12 at which the leg plate 12B is disposed. An aperture 12D is formed in the leg plate 12B. A lock base 20 and a main lock 22, which are described below, are disposed at an inner periphery portion of the aperture 12D. Plural lock teeth 12E are formed along the circumferential direction at an inner edge of the aperture 12D. The main lock 22 engages with the lock teeth 12E. A take-up urging mechanism, which is not shown in the drawings, is provided at a side of the frame 12 at which the leg plate 12C is disposed. The take-up urging mechanism urges the spool 14 to rotate in a take-up direction.

The spool 14 is formed substantially in a circular tube shape. The spool 14 is rotatably supported at the frame 12 between the leg plate 12B and the leg plate 12C of the frame 12. A publicly known torsion shaft constituting a force limiter mechanism is disposed inside the spool 14. As shown in FIG. 1, the lock base 20 is provided at an end portion in an axis direction one side (the side in the direction of arrow Z) of the spool 14. The lock base 20 is coupled to the spool 14 via the torsion shaft, which is not shown in the drawings. A V gear support portion 20A is provided standing toward the axis direction one side from a diameter direction central portion of the lock base 20. A V gear 24, which is described below, is supported at the V gear support portion 20A.

The webbing 16 is to be applied to the body of a vehicle occupant. A base end portion of the webbing 16, which is a length direction one end portion, is anchored at the spool 14. A spiral spring constitutes a portion of the take-up urging mechanism. The spool 14 is urged to rotate in the take-up direction, which is one rotation direction (the direction of arrow C in FIG. 1 and the like), by urging force of the spiral spring. When the spool 14 rotates in the take-up direction, the webbing is taken up onto the spool 14 starting from the base end side of the webbing. When the webbing is pulled out from the spool 14, the spool 14 is turned in a pull-out direction, which is the other rotation direction (the opposite direction from arrow C in FIG. 1 and the like).

Now the lock mechanism 18, which is a principal portion of the present exemplary embodiment, is described.

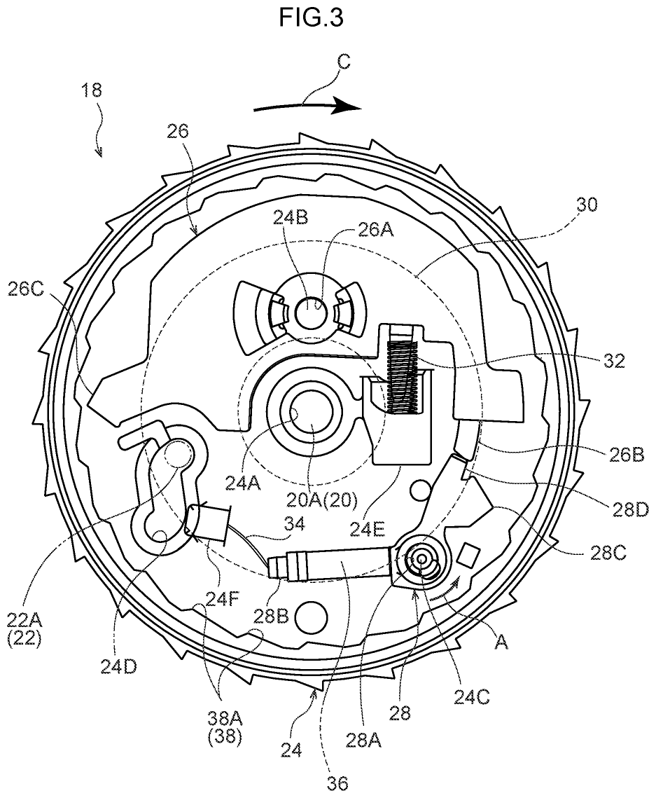

As shown in FIG. 1 and FIG. 2, the lock mechanism 18 is structured with the main lock 22 (see FIG. 3), the V gear 24, a W pawl 26, a small pawl 28 and a coil 30 serving as the major principal portions thereof. The main lock 22 is supported at the lock base 20. The V gear 24 is rotatably supported at the lock base 20. The W pawl 26 and the small pawl 28 are supported at the V gear 24.

The main lock 22 is formed in a substantially rectangular block shape. A proximal end side of the main lock 22 is tiltably supported at a main lock support portion that is provided at the lock base 20. Main lock-side engaging teeth are formed at a diameter direction outer side of a distal end of the main lock 22. The main lock-side engaging teeth engage with the lock teeth 12E of the frame 12. The structure of the main lock 22 is similar to publicly known structures. Accordingly, descriptions using diagrams of the proximal end side of the main lock 22, the main lock-side engaging teeth at a distal end side and the like are not given here. When the main lock 22 is tilted (displaced) to the diameter direction outer side, with the main lock support portion acting as a spindle, the main lock-side engaging teeth engage with the lock teeth 12E of the frame 12. As shown in FIG. 3, a V gear engaging protrusion 22A is formed at the main lock 22. The V gear engaging protrusion 22A protrudes to one side in the axis direction.

The V gear 24 is formed in a circular plate shape. A support hole 24A is formed at an diameter direction center of the V gear 24. The V gear support portion 20A provided at the rotation center of the lock base 20 (see FIG. 1) is inserted through the support hole 24A. Because the V gear support portion 20A of the lock base 20 is inserted through the support hole 24A, the V gear 24 is rotatable with the V gear support portion 20A acting as a spindle.

A W pawl support portion 24B supports the W pawl 26, which is described below. The W pawl support portion 24B is provided standing to the axis direction one side at an outer side in the diameter direction of a region of the V gear 24 in which the support hole 24A is formed. A small pawl support portion 24C supports the small pawl 28, which is described below. The small pawl support portion 24C is provided standing to the axis direction one side at an outer side in the diameter direction of the region of the V gear 24 in which the support hole 24A is formed. The small pawl support portion 24C is provided at one side in the circumferential direction of the region in which the W pawl 26, which is supported at the W pawl support portion 24B, is disposed. An operation slot 24D with a long hole shape is formed at an outer side in the diameter direction of the region of the V gear 24 in which the support hole 24A is formed. The operation slot 24D is formed at a region that does not overlap in the axis direction with the W pawl 26, which is supported at the W pawl support portion 24B, or with the small pawl 28, which is supported at the small pawl support portion 24C. The V gear engaging protrusion portion 22A of the main lock 22 is disposed inside the operation groove 24D. A spring, which is not shown in the drawings, is provided between the V gear 24 and the lock base 20. The V gear 24 described above is urged to rotate in the pull-out direction relative to the lock base 20 by this spring, and rotation of the V gear 24 in the pull-out direction relative to the lock base 20 is stopped by the spring.

The W pawl 26 is formed in a block shape, which is substantially a half-moon shape as seen in the axis direction. A support hole 26A is formed in the W pawl 26 at a middle portion thereof in the circumferential direction and the diameter direction. The W pawl support portion 24B of the V gear 24 is inserted through the support hole 26A. Because the W pawl support portion 24B of the V gear 24 is inserted through the support hole 26A, the W pawl 26 is tiltable (displaceable) with the W pawl support portion 24B acting as a spindle.

A coil spring 32 that urges the W pawl 26 is engaged with one side in the circumferential direction (the side in the direction of arrow C) of the W pawl 26. The coil spring 32 is compressed between the W pawl 26 and a coil spring anchoring portion 24E provided at the V gear 24. A small pawl-abutting portion 26B protrudes to the circumferential direction one side (the side in the direction of arrow C) from an end portion at the circumferential direction one side of the W pawl 26. The small pawl-abutting portion 26B abuts against the small pawl 28, which is described below.

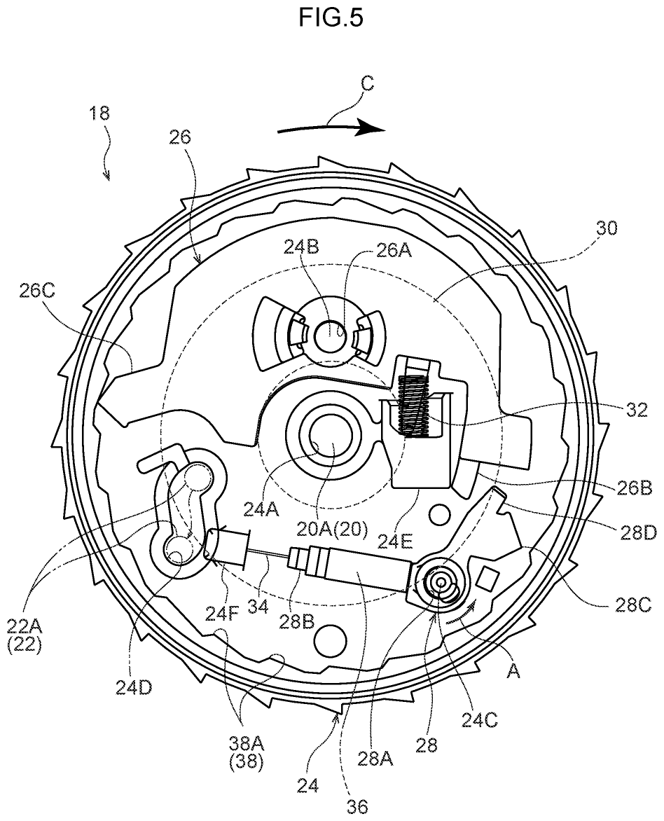

A single W pawl side engaging tooth 26C is formed at an end portion at the other side in the circumferential direction (the opposite side from the direction of arrow C) of the W pawl 26. The W pawl side engaging tooth 26C engages with pawl engaging teeth 38A formed at a sensor holder 38, which is described below. When the W pawl 26 tilts to one side in opposition to the urging force of the coil spring 32 with the W pawl support portion 24B of the V gear 24 acting as a spindle (tilts such that the side of the W pawl 26 at which the W pawl side engaging tooth 26C is provided displaces to the diameter direction outer side), as shown in FIG. 5, the W pawl side engaging tooth 26C engages with the pawl engaging teeth 38A of the sensor holder 38. Note that a position of the W pawl 26 in a state in which tilting of the W pawl 26 is limited by the urging force of the coil spring 32 serves as an “allowing position”, and a position of the W pawl 26 in the state in which the W pawl side engaging tooth 26C may engage with the pawl engaging teeth 38A of the sensor holder 38 serves as a “locking position”. In the present exemplary embodiment, when a rotation speed of the spool 14 in the pull-out direction exceeds a predetermined speed, centrifugal force acting on the W pawl 26 exceeds the urging force of the coil spring 32 and the W pawl 26 tilts to the one side.

As shown in FIG. 3, the small pawl 28 is formed in an L-shaped block shape that is smaller than the W pawl 26. A support hole 28A is formed at the small pawl 28 at a middle portion thereof in the circumferential direction. The small pawl support portion 24C of the V gear 24 is inserted through the support hole 28A. Because the small pawl support portion 24C of the V gear 24 is inserted through the support hole 28A, the small pawl 28 is tiltable (displaceable) with the small pawl support portion 24C acting as a spindle.

An end portion at one side in the circumferential direction (the side in the direction of arrow C) of the small pawl 28 is formed as a plate spring anchoring portion 28B. An end portion at one side of a plate spring 34 is anchored at the plate spring anchoring portion 28B. The plate spring 34 urges the small pawl 28 to a middle position side thereof, which is described below. An end portion at the other side of the plate spring 34 is anchored at a plate spring anchoring portion 24F, which is provided at the V gear 24.

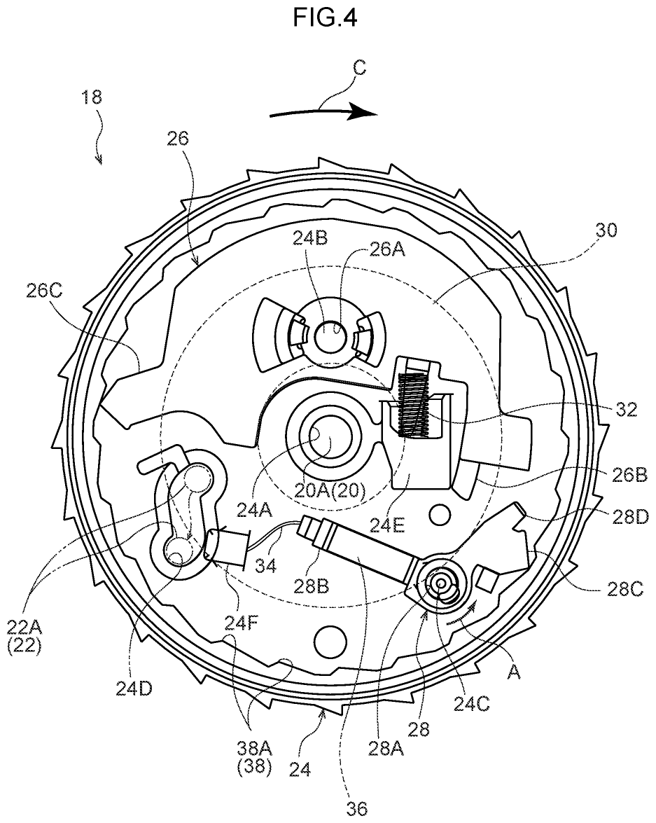

A single small pawl side engaging tooth 28C is provided at an outer side in the diameter direction of the small pawl 28. The single small pawl side engaging tooth 28C is provided at an end portion at the other side in the circumferential direction (the opposite side from the direction of arrow C). The small pawl side engaging tooth 28C engages with the pawl engaging teeth 38A formed at the sensor holder 38, which is described below. When the small pawl 28 tilts to one side (the side in the opposite direction from arrow A) in opposition to urging force of the plate spring 34 with the small pawl support portion 24C of the V gear 24 acting as a spindle (tilts such that the side of the small pawl 28 at which the small pawl side engaging tooth 28C is provided displaces to the diameter direction outer side), as shown in FIG. 4, the small pawl side engaging tooth 28C engages with the pawl engaging teeth 38A of the sensor holder 38.

A W pawl-limiting portion 28D is provided protruding to the other side in the circumferential direction (the opposite side from the direction of arrow C) from an inner side in the diameter direction of an end portion, which is at the other side in the circumferential direction, of the small pawl 28. When the small pawl 28 tilts to the other side (the side in the direction of arrow A) in opposition to the urging force of the plate spring 34 with the small pawl support portion 24C of the V gear 24 acting as a spindle, as shown in FIG. 3, the W pawl-limiting portion 28D is disposed in close proximity in the circumferential direction with the small pawl-abutting portion 26B of the W pawl 26. Hence, when the small pawl-abutting portion 26B of the W pawl 26 abuts against the W pawl-limiting portion 28D, tilting of the W pawl 26 to the locking position side from the allowing position is limited.

A position of the small pawl 28 in the state in which the W pawl-limiting portion 28D and the small pawl-abutting portion 26B of the W pawl 26 are disposed in close proximity in the circumferential direction is referred to as a “W pawl limiting position” (the position shown in FIG. 3). A position of the small pawl 28 in the state in which the small pawl side engaging tooth 28C may engage with the pawl engaging teeth 38A of the sensor holder 38 is referred to as a “lock position” (the position shown in FIG. 4). A position of the small pawl 28 in a state in which tilting of the small pawl 28 is limited by the urging force of the plate spring 34, which is between the W pawl-limiting position and the lock position, is referred to as a middle position (the position shown in FIG. 5). In the state in which the small pawl 28 is disposed at the middle position as shown in FIG. 5, the small pawl side engaging tooth 28C does not engage with the pawl engaging teeth 38A of the sensor holder 38 and the small pawl-abutting portion 26B of the W pawl 26 does not abut against the W pawl-limiting portion 28D.

A magnet 36 is fixed (for example, enclosed) at one side in the circumferential direction (the side in the direction of arrow C) of the small pawl 28. A south pole and north pole of the magnet 36 are oriented in the axis direction.

As shown in FIG. 1 and FIG. 2, the coil 30 is provided at one side in the axis direction of the small pawl 28. The coil 30 is formed by winding of a wire member in the circumferential direction about the rotation axis of the spool 14. Most of the coil 30 is disposed in a coil accommodation body 40. The coil accommodation body 40 is formed, using a resin material, in a circular plate shape. Electric current is applied to the coil 30 through terminal portions of the coil 30, which are not shown in the drawings and which protrude from the coil accommodation body 40. A portion of the coil 30 in the circumferential direction is disposed in close proximity in the axis direction with the circumferential direction one side (the side in the direction of arrow C) of the small pawl 28 (with the region in which the magnet 36 is fixed). When electric current is applied to the coil 30 in one direction, the small pawl 28 is tilted toward the W pawl limiting position. When electric current is applied to the coil 30 in the other direction, the small pawl 28 is tilted toward the lock position.

The V gear 24, W pawl 26, small pawl 28, coil 30 and so forth described above are disposed in the sensor holder 38, which is attached to the leg plate 12B of the frame 12. In the state in which the sensor holder 38 is attached to the leg plate 12B of the frame 12, the W pawl 26 and small pawl 28 are disposed to oppose the pawl engaging teeth 38A of the sensor holder 38 in the diameter direction.

### Operation and Effects of the Present Exemplary Embodiment

Now, operation and effects of the present exemplary embodiment are described.

As shown in FIG. 1, in the webbing take-up device 10 according to the present exemplary embodiment, the webbing 16 is pulled out from the spool 14 and applied to a vehicle occupant sitting on a vehicle seat. When the vehicle occupant sitting on the vehicle seat removes the applied webbing 16, the spool 14 is rotated in the take-up direction by the take-up urging mechanism, which is not shown in the drawings, and takes up the webbing 16 onto the spool 14.

When a vehicle occupant boarding the vehicle and sitting on the vehicle seat is detected by a sensor, electric current is applied to the coil 30 in the one direction, as shown in FIG. 3. Consequently, the small pawl 28 tilts from the middle position to the W pawl limiting position, and the W pawl-limiting portion 28D of the small pawl 28 and small pawl-abutting portion 26B of the W pawl 26 are disposed in close proximity in the circumferential direction. In this state, tilting of the W pawl 26 from the allowing position to the locking position side is limited. Therefore, the vehicle occupant sitting on the vehicle seat may pull out the webbing 16 from the spool 14 quickly and apply the webbing 16. Thus, in the present exemplary embodiment, unnecessary locking of rotation of the spool 14 at a time of application of the webbing 16 may be prevented or suppressed.

In a state in which application of the webbing 16 to the vehicle occupant is complete, the application of electric current to the coil 30 is stopped. As a result, the small pawl 28 is tilted from the W pawl limiting position to the middle position by the urging force of the plate spring 34.

When a sensor or the like provided at the vehicle detects that a deceleration of the vehicle exceeds a predetermined deceleration (at a time of emergency of the vehicle or the like), electric current is applied to the coil 30 in the other direction, as shown in FIG. 4. Consequently, the small pawl 28 is tilted from the middle position to the lock position, and the small pawl side engaging tooth 28C engages with the pawl engaging teeth 38A of the sensor holder 38. Hence, rotation of the small pawl 28, which is engaged with the pawl engaging teeth 38A of the sensor holder 38, and of the V gear 24 supporting the small pawl 28 is limited.

In a case in which the body of the vehicle occupant sitting on the vehicle seat moves toward the seat front side due to the deceleration of the vehicle, and the webbing 16 is pulled out from the spool 14, the spool 14 is rotated in the pull-out direction together with the main lock 22. Consequently, the V gear engaging protrusion portion 22A of the main lock 22 moves along the operation slot 24D of the V gear 24 whose rotation is limited (moves in a direction depicted by a two-dot chain line arrow), and the main lock side engaging teeth of the main lock 22 engage with the lock teeth 12E of the frame 12 (see FIG. 1). Hence, rotation of the spool 14 in the pull-out direction is limited and pulling out of the webbing 16 from the spool 14 is limited. Accordingly, the body of the vehicle occupant sitting on the vehicle seat is restrained by the webbing 16.

When the vehicle returns to usual running after a time of emergency, the application of electric current to the coil 30 is stopped. Consequently, the small pawl 28 is tilted from the lock position to the middle position by the urging force of the plate spring 34, the spool 14 is turned in the take-up direction by the take-up urging mechanism that is not shown in the drawings, and the webbing 16 that has been pulled out from the spool 14 is taken up onto the spool 14.

In a state in which electric current cannot be applied to the coil 30 due to a disconnection of wiring or the like, when the vehicle rapidly decelerates and the body of the vehicle occupant moves toward the seat front side, the webbing 16 is suddenly pulled out from the spool 14. As a result, the V gear 24 is rotated in the pull-out direction together with the W pawl 26. If the rotation speed of the spool 14 in the pull-out direction exceeds the predetermined speed, centrifugal force acting on the W pawl 26 exceeds the urging force of the coil spring 32. Thus, as shown in FIG. 5, the W pawl 26 tilts from the allowing position to the locking position, and the W pawl side engaging tooth 26C of the W pawl 26 engages with the pawl engaging teeth 38A of the sensor holder 38. Hence, rotation of the W pawl 26, which is engaged with the pawl engaging teeth 38A of the sensor holder 38, and of the V gear 24 supporting the W pawl 26 is limited. Further, when the body of the vehicle occupant moves toward the seat front side and the webbing 16 is pulled out further from the spool 14, the spool 14 is rotated in the pull-out direction together with the main lock 22. Therefore, the V gear engaging protrusion portion 22A of the main lock 22 moves along the operation slot 24D of the V gear 24 whose rotation is limited (moves in the direction depicted by the two-dot chain line arrow), and the main lock side engaging teeth of the main lock 22 engage with the lock teeth 12E of the frame 12. Hence, rotation of the spool 14 in the pull-out direction is limited and pulling out of the webbing 16 from the spool 14 is limited. Accordingly, the body of the vehicle occupant sitting on the vehicle seat is restrained by the webbing 16. Thus, in the present exemplary embodiment, even in a state in which electric current cannot be applied to the coil 30, the body of the vehicle occupant sitting on the vehicle seat may be restrained by the webbing 16 at a time of rapid deceleration of the vehicle.

In the present exemplary embodiment, the W pawl 26 and the small pawl 28 are structured to engage with the same pawl engaging teeth 38A disposed at the diameter direction outer side of the W pawl 26 and the small pawl 28. Therefore, an increase in overall size of the webbing take-up device 10 may be suppressed compared to a structure in which portions with which the W pawl 26 and the small pawl 28 engage are provided separately.

In the present exemplary embodiment, the plate spring 34 is provided, which urges the small pawl 28 that has been displaced to the W pawl limiting position side or lock position side thereof to the middle position side thereof. Therefore, in states in which electric current is not being applied to the coil 30, the small pawl 28 may be retained at the middle position simply.

In the present exemplary embodiment, the coil 30 and the magnet 36 fixed to the small pawl 28 are disposed to be adjacent in the axis direction. Therefore, an increase in overall size of the webbing take-up device 10 in the diameter direction may be suppressed.

In the present exemplary embodiment, an increase in overall size of the webbing take-up device 10 may be suppressed compared to a structure in which a magnetic field generated by applying electric current to the coil 30 is propagated to the vicinity of the magnet 36 via an iron core.

In the present exemplary embodiment, an example is described in which the plate spring 34 is provided that urges the small pawl 28 that has been displaced to the W pawl limiting position side or the lock position side to the middle position side, but the present invention is not limited thus. For example, a structure is possible that is not provided with the plate spring 34 but returns the small pawl 28 displaced to the W pawl limiting position side or lock position side to the middle position side by switching electrification of the coil 30.

In the present exemplary embodiment, an example is described in which the small pawl 28 is tilted by electric current being applied to the coil 30, but the present invention is not limited thus. For example, the small pawl 28 may be displaced by a mechanical structure utilizing friction or the like.

In the present exemplary embodiment, an example is described in which the W pawl 26 and small pawl 28 engage with the same pawl engaging teeth 38A disposed at the diameter direction outer side of the W pawl 26 and small pawl 28, but the present invention is not limited thus. Structures are possible in which portions with which the W pawl 26 and small pawl 28 engage are provided separately.

### Alternative Embodiment of the Lock Mechanism

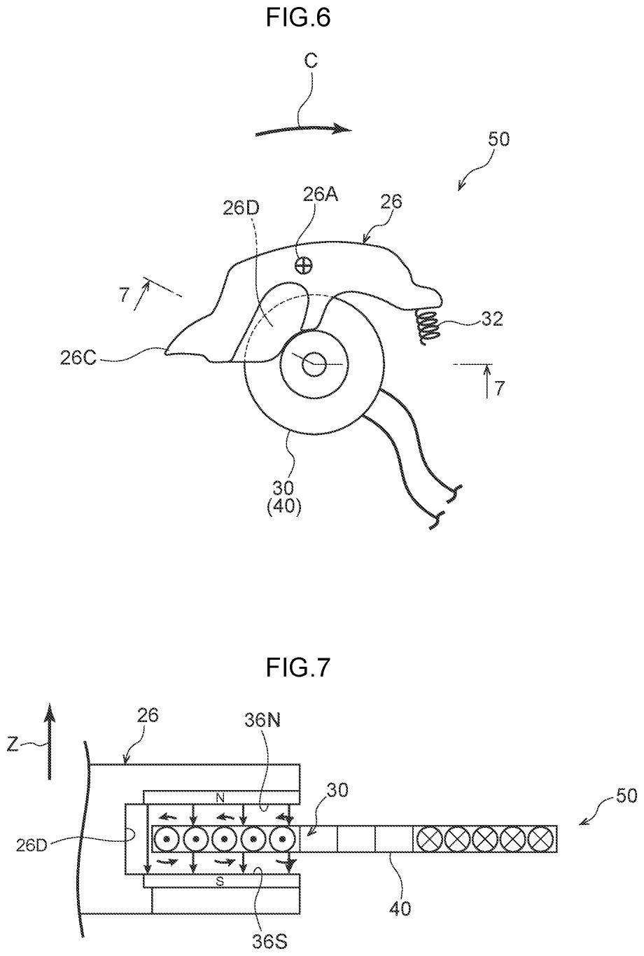

Now, a lock mechanism 50 according to an alternative embodiment is described using FIG. 6 to FIG. 9. Members and portions of the lock mechanism 50 that correspond with the webbing take-up device 10 described above are assigned the same reference symbols as the corresponding members and portions of the webbing take-up device 10 and descriptions thereof are not given.

As shown in FIG. 6, the lock mechanism 50 according to the present embodiment is characterized by the functions of the small pawl 28 described above (see FIG. 3) being assigned to the W pawl 26, which serves as a locking member. More specifically, as shown in FIG. 6 and FIG. 7, a coil accommodation slot 26D is formed in an inner periphery portion at another side in the circumferential direction of the W pawl 26. A portion in the circumferential direction of the coil 30 (and the coil accommodation body 40) is disposed inside the coil accommodation slot 26D.

As shown in FIG. 7, a magnet 36N is fixed at one side in the axis direction of an inner periphery face of the coil accommodation slot 26D. The north pole side of the magnet 36N is oriented to the side thereof at which the coil 30 is disposed. A magnet 36S is fixed at another side in the axis direction of the inner periphery face of the coil accommodation slot 26D. The south pole side of the magnet 36S is oriented to the side thereof at which the coil 30 is disposed. Thus, the portion in the circumferential direction of the coil 30 is disposed between the magnet 36N and the magnet 36S.

In the lock mechanism 50 described above, when a vehicle occupant boarding the vehicle and sitting on the vehicle seat is detected by a sensor, as shown in FIG. 7, electric current is applied to the coil 30 in one direction, and the current flows in a direction toward a viewer of FIG. 7 in the portion of the coil 30 disposed between the magnet 36N and the magnet 36S. As a result, the region of the W pawl 26 at which the magnets 36N and 36S are fixed is urged toward an inner side in the diameter direction, and the W pawl 26 is resistant to tilting from the allowing position to the locking position side. Therefore, the vehicle occupant sitting on the vehicle seat may pull out the webbing 16 (see FIG. 1) from the spool 14 (see FIG. 1) quickly and apply the webbing 16. Thus, in the present exemplary embodiment, unnecessary locking of rotation of the spool 14 at a time of application of the webbing 16 may be prevented or suppressed.

In a state in which application of the webbing 16 to the vehicle occupant is complete, the application of electric current to the coil 30 is stopped.

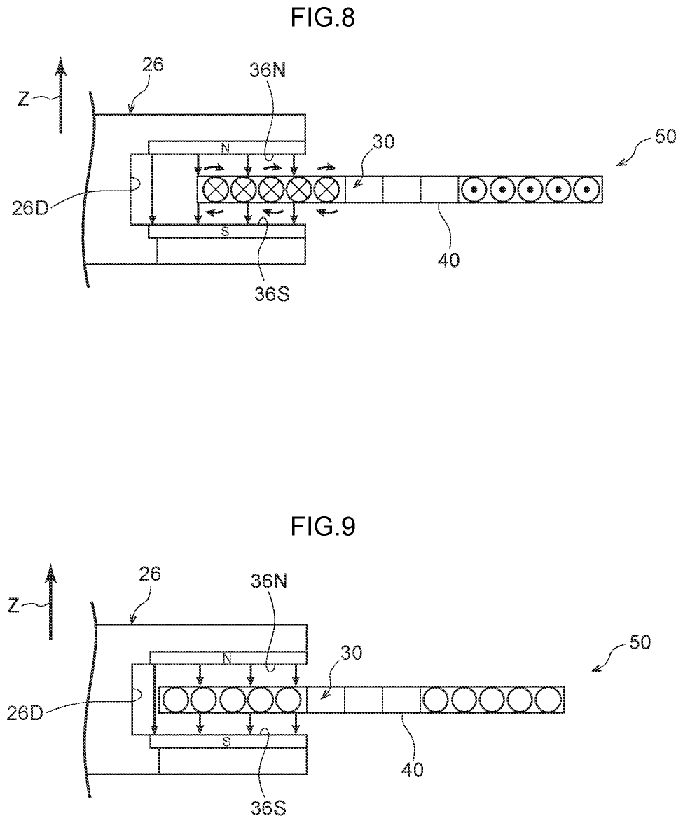

When a sensor or the like provided at the vehicle detects that a deceleration of the vehicle exceeds a predetermined deceleration (at a time of emergency of the vehicle or the like), as shown in FIG. 8 (see also FIG. 1, FIG. 2 and FIG. 4), electric current is applied to the coil 30 in the other direction, and the current flows in the direction away from a viewer of FIG. 8 in the portion of the coil 30 disposed between the magnet 36N and the magnet 36S. As a result, the region of the W pawl 26 at which the magnets 36N and 36S are fixed is urged toward an outer side in the diameter direction, and the W pawl 26 tilts from the allowing position to a locking position side. Hence, rotation of the W pawl 26 that is engaged with the pawl engaging teeth 38A of the sensor holder 38 and rotation of the V gear 24 supporting the W pawl 26 is limited.

If the body of the vehicle occupant moves toward the seat front side due to the deceleration of the vehicle, and the webbing 16 is pulled out from the spool 14, the spool 14 is rotated in the pull-out direction together with the main lock 22. Therefore, the V gear engaging protrusion portion 22A of the main lock 22 moves along the operation slot 24D of the V gear 24 whose rotation is limited, and the main lock side engaging teeth of the main lock 22 engage with the lock teeth 12E of the frame 12. Hence, rotation of the spool 14 in the pull-out direction is limited and pulling out of the webbing 16 from the spool 14 is limited. Accordingly, the body of the vehicle occupant sitting on the vehicle seat is restrained by the webbing 16.

As shown in FIG. 9 (see also FIG. 1, FIG. 2 and FIG. 5), in a state in which electric current cannot be applied to the coil 30 due to a disconnection of wiring or the like, when the vehicle rapidly decelerates and the body of the vehicle occupant moves toward the seat front side, the webbing 16 is suddenly pulled out from the spool 14. As a result, the V gear 24 is rotated in the pull-out direction together with the W pawl 26. If the rotation speed of the spool 14 in the pull-out direction exceeds the predetermined speed, centrifugal force acting on the W pawl 26 exceeds the urging force of the coil spring 32. Thus, the W pawl 26 tilts from the allowing position to the locking position, and the W pawl side engaging tooth 26C of the W pawl 26 engages with the pawl engaging teeth 38A of the sensor holder 38. Hence, rotation of the W pawl 26 that is engaged with the pawl engaging teeth 38A and of the V gear 24 supporting the W pawl 26 is limited. Further, when the body of the vehicle occupant moves toward the seat front side and the webbing 16 is pulled out further from the spool 14, the spool 14 is rotated in the pull-out direction together with the main lock 22. Therefore, the V gear engaging protrusion portion 22A of the main lock 22 moves along the operation slot 24D of the V gear 24 whose rotation is limited, and the main lock side engaging teeth of the main lock 22 engage with the lock teeth 12E of the frame 12. Hence, rotation of the spool 14 in the pull-out direction is limited and pulling out of the webbing 16 from the spool 14 is limited. Accordingly, the body of the vehicle occupant sitting on the vehicle seat is restrained by the webbing 16. Thus, in the present exemplary embodiment, even in a state in which electric current cannot be applied to the coil 30, the body of the vehicle occupant sitting on the vehicle seat may be restrained by the webbing 16 at a time of rapid deceleration of the vehicle.

In the lock mechanism 50 described above, an increase in overall size of the webbing take-up device may be suppressed compared to a structure in which a magnetic field generated by applying electric current to the coil 30 is propagated to the vicinity of the magnet 36 via an iron core.

The coil 30 and the magnets 36N and 36S fixed to the W pawl 26 are disposed to be adjacent in the axis direction. Therefore, an increase in overall size of the webbing take-up device 10 in the diameter direction may be suppressed. Further, because the portion in the circumferential direction of the coil 30 is disposed between the magnet 36N and the magnet 36S, the force acting to tilt the W pawl 26 may be increased (may be made larger than in a structure in which the coil is disposed in close proximity to a single magnet).

In the lock mechanism 50 described above, the W pawl 26 is tilted from the allowing position to the locking position by the application of electric current to the other direction side to the coil 30, but the present invention is not limited thus. For example, a structure is possible in which the W pawl 26 is urged toward the locking position side, by the application of electric current to the other direction side to the coil 30, so as to assist tilting of the W pawl 26 to the locking position side by centrifugal force. Thus, rotation of the spool 14 in the pull-out direction may be locked quickly.

Hereabove, exemplary embodiments of the present invention are described. The present invention is not limited by these descriptions and it will be clear that numerous modifications beyond these descriptions may be embodied within a technical scope not departing from the scope of the invention.

The disclosures of Japanese Patent Application No. 2019-074160 are incorporated into the present specification by reference in their entirety.

All references, patent applications and technical specifications cited in the present specification are incorporated by reference into the present specification to the same extent as if the individual references, patent applications and technical specifications were specifically and individually recited as being incorporated by reference.

1. A webbing take-up device, comprising:
a spool onto which is taken up a webbing that is configured to be applied to a vehicle occupant, the spool being rotated in a pull-out direction by the webbing being pulled out;
a locking member that is integrally rotatable with the spool and displaceable relative to the spool, the locking member locking rotation of the spool in the pull-out direction in a case in which the locking member is displaced to a locking position;
a magnet fixed to the locking member; and
a coil formed by winding of a conductive wire, the coil being disposed in close proximity with the magnet,
wherein the locking member is displaced or urged in a case in which electric current is applied to the coil.

2. The webbing take-up device according to claim 1, wherein:
the locking member is displaced or urged toward a locking position side thereof in a case in which electric current is applied to the coil in one direction, and
the locking member is displaced or urged toward an opposite side thereof from the locking position in a case in which electric current is applied to the coil in another direction.

3. The webbing take-up device according to claim 1 wherein, in a case in which a rotation speed of the spool in the pull-out direction exceeds a predetermined speed, the locking member is displaced toward the locking position by centrifugal force.

4. The webbing take-up device according to claim 1, wherein:
a pair of the magnets are fixed to the locking member, and
the coil is disposed between the pair of magnets.

5. The webbing take-up device according to claim 1, wherein the magnet and the coil are disposed adjacent to each other in a rotation axis direction of the spool.

6. The webbing take-up device according to claim 1, wherein the locking member includes a first locking member and a second locking member, and the magnet is fixed to the first locking member.

7. The webbing take-up device according to claim 6, further comprising a holder that is non-rotatable relative to the spool,
wherein, by electric current being applied to the coil, the first locking member is displaced to the locking position, an engaged portion of the first locking member is engaged with an engaging portion of the holder, and rotation of the spool in the pull-out direction is locked.

8. The webbing take-up device according to claim 6, wherein the first locking member and the second locking member are each displaceable relative to the spool in at least a circumferential direction or a diameter direction of the spool.
